(19) United States
(12) Patent Application Publication
(10) Pub. No.: US 2022/0124239 A1
(43) Pub. Date: Apr. 21, 2022

(54) OPERATING METHOD

(71) Applicant: SEIKO EPSON CORPORATION, Tokyo (JP)

(72) Inventors: Yuichi KAKIZAKI, Ueda-shi (JP); Hiroaki BABA, Nagano-shi (JP); Shinya SATO, Matsumoto-shi (JP)

(73) Assignee: SEIKO EPSON CORPORATION, Tokyo (JP)

(21) Appl. No.: 17/502,797

(22) Filed: Oct. 15, 2021

(30) Foreign Application Priority Data
Oct. 16, 2020 (JP) 2020-174558

(51) Int. Cl. H04N 5/232; G06K 9/00

(52) U.S. Cl. CPC H04N 5/23216; G06K 9/00671

(57) ABSTRACT

An operating method of a display system including an HMD including an image display unit, with an outside scene visible, for superimposing and displaying an image on the outside scene, and a DP outer camera mounted on the image display unit, the display device being configured to be mounted on a head of a user, and a control device having a touch panel for accepting operation, the operating method including displaying an operation image for accepting operation by the user on the touch panel, displaying an adjustment image for adjusting a captured image captured by the DP outer camera, in a display region of an image of the image display unit, changing a display position of the adjustment image by operation on the operation image, and causing the DP outer camera to perform imaging by operation on the operation image.

The present application is based on, and claims priority from JP Application Serial Number 2020-174558, filed Oct. 16, 2020, the disclosure of which is hereby incorporated by reference herein in its entirety.

### BACKGROUND

### 1. Technical Field

The present disclosure relates to an operating method and a program.

### 2. Related Art

In the past, a display device has been known that includes a display unit mounted on a head of a user, and causes the display unit to display a captured image captured by an imaging unit mounted on the display unit (see, for example, JP 2005-38321 A).

However, when an information processing device is coupled to the display device, and operation by the user is accepted by the information processing device, the display unit is mounted on the head of the user, so there has been a problem in that visibility of the information processing device deteriorates, and operability of the information processing device deteriorates.

### SUMMARY

An aspect for solving the above-described problem is an operating method of a display system including a display device including a display unit through which an outside scene is visible and configured to display an image superimposed on the outside scene, and an imaging unit mounted on the display unit, the display device being configured to be mounted on a head of a user, and an information processing device having an operating surface for accepting operation, the operating method including displaying an operation image for accepting operation by the user on the operating surface, displaying an adjustment image for adjusting the imaging unit, or a captured image captured by the imaging unit, in a display region of an image of the display unit, changing display of the adjustment image by operation accepted on the operation image, and causing the imaging unit to perform imaging by the operation accepted on the operation image.

An aspect for solving the above-described problem is a non-transitory computer-readable storage medium storing a program executed by a computer, the computer including a display device including a display unit through which an outside scene is visible and configured to display an image superimposed on the outside scene, and an imaging unit mounted on the display unit, the display device being configured to be mounted on a head of a user, and an information processing device having an operating surface for accepting operation, the program including displaying an operation image for accepting operation by the user on the operating surface, displaying an adjustment image for adjusting the imaging unit, or a captured image captured by the imaging unit, in a display region of an image of the display unit, changing display of the adjustment image by operation accepted on the operation image, and causing the imaging unit to perform imaging by the operation accepted on the operation image.

### BRIEF DESCRIPTION OF THE DRAWINGS

FIG. 1 is a diagram illustrating a schematic configuration of a display system.

FIG. 2 is a main part plan view illustrating a configuration of an optical system of an image display unit.

FIG. 3 is a block diagram of the display system.

FIG. 4 is a block diagram of a control device and a main control unit.

FIG. 5 is a diagram illustrating a virtual joystick controller in a first display mode.

FIG. 6 is a diagram illustrating the virtual joystick controller in a second display mode.

FIG. 7 is a diagram illustrating the virtual joystick controller in a third display mode.

FIG. 8 is a diagram illustrating a state in which the virtual joystick controller is displayed at a position touched by a thumb of a user.

FIG. 9 is an explanatory diagram explaining a case in which a display image displayed by the image display unit is operated by the virtual joystick controller.

FIG. 10 is an explanatory diagram explaining the case in which the display image displayed by the image display unit is operated by the virtual joystick controller.

FIG. 11 is an explanatory diagram explaining a case in which setting for imaging by a DP outer camera is operated by the virtual joystick controller.

FIG. 12 is an explanatory diagram explaining the case in which the setting for imaging by the DP outer camera is operated by the virtual joystick controller.

FIG. 13 is a flowchart illustrating operation of a CO control unit.

### DESCRIPTION OF EXEMPLARY EMBODIMENTS

1. Configuration of Display System

An exemplary embodiment to which the present disclosure is applied will be described below with reference to the drawings.

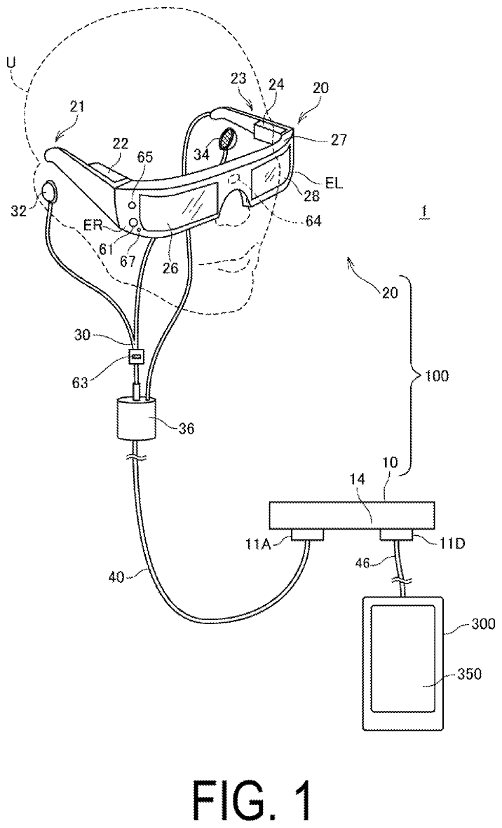

FIG. 1 is a diagram illustrating a schematic configuration of a display system 1.

The display system 1 includes an HMD 100 and a control device 300. The HMD 100 is a head-mounted display apparatus including an image display unit 20 mounted on a head of a user U, and causing the user U to visually recognize an image or video, and is an example of a display device of the present disclosure. HMD is an abbreviation for Head Mounted Display. The control device 300 is an example of an information processing device of the present disclosure. Further, the image display unit 20 is an example of a display unit of the present disclosure.

The HMD 100 includes a connection device 10 coupled to the image display unit 20. The connection device 10 functions as an interface for coupling the HMD 100 to a device different from the HMD 100. In the display system 1, the control device 300 is coupled to the connection device 10.

In the following description and drawings, for the sake of convenience of description, a prefix DP is added to a name of each of some functional units constituting the HMD 100, and a prefix CO is added to a name of each of some functional units constituting the control device 300.

The control device 300 is provided with a display screen that displays characters and images, and a touch panel 350 that functions as an operating unit for detecting touch operations and pressing operations, and is a portable size terminal device, and for example, a smart phone can be used. The touch panel 350 is constituted by a display panel and a touch sensor. LCD is an abbreviation for Liquid Crystal Display. The control device 300 may be a desktop personal computer, a notebook personal computer, a tablet personal computer, or the like.

The connection device 10 includes a connector 11A and a connector 11D on a box shaped case. The image display unit 20 is coupled to the connector 11A via a coupling cable 40, and the control device 300 is coupled to the connector 11D via a USB cable 46. As a result, the image display unit 20 and the control device 300 are coupled to each other so that data can be transmitted and received. For example, the control device 300 outputs video data and sound data for the image display unit 20 to display video to the image display unit 20. Further, the image display unit 20 transmits detection data of various sensors included in the image display unit 20 to the control device 300, as described below. The control device 300 may be capable of supplying power to the image display unit 20. USB is an abbreviation for Universal Serial Bus.

The configuration of coupling the connection device 10 and the control device 300 using the USB cable 46 is merely an example, and a specific coupling form of the connection device 10 and the control device 300 is not limited. For example, other types of cables may be used for wired coupling or coupling via wireless communication may be used. For example, in a configuration in which the USB cable 46 is coupled to the connector 11D of a USB-TypeC standard, 20 volts DC current can be supplied by the USB cable 46, and HDMI standard video data or the like can be transmitted as a function of an alternate mode of USB-TypeC standard. HDMI and MHL are registered trademarks.

The image display unit 20 includes a main body including a right holding part 21, a left holding part 23, and a front frame 27. The main body further includes a right display unit 22, a left display unit 24, a right light-guiding plate 26, and a left light-guiding plate 28.

The right holding part 21 and the left holding part 23 extend rearward from corresponding ends of the front frame 27, to hold the image display unit 20 on the head of the user U. The right holding part 21 is coupled to an end portion ER located on a right side of the user U in the front frame 27, and the left holding part 23 is coupled to an end portion EL located on a left side of the user U.

The right light-guiding plate 26 and the left light-guiding plate 28 are provided on the front frame 27. The right light-guiding plate 26 is located in front of the right eye of the user U in a state where the user U wears the image display unit 20, and causes the user U to visually recognize an image with the right eye. The left light-guiding plate 28 is located in front of the left eye of the user U in a state where the user U wears the image display unit 20, and causes the user U to visually recognize an image with the left eye. The right light-guiding plate 26 and the left light-guiding plate 28 are optical units formed of a light transmissive resin or the like, and are configured to guide imaging light output by the right display unit 22 and the left display unit 24 to the eyes of the user U. The right light-guiding plate 26 and the left light-guiding plate 28 are, for example, prisms.

The front frame 27 has a shape formed by coupling an end of the right light-guiding plate 26 and an end of the left light-guiding plate 28 to each other, and this coupling position corresponds to a position between eyebrows of the user U in a state where the user U wears the image display unit 20. The front frame 27 may include a nose pad abutting the nose of the user U in a state where the user U wears the image display unit 20, and may be configured to couple a belt to the right holding part 21 and the left holding part 23 to hold the image display unit 20 to the head of the user U by the belt.

Each of the right display unit 22 and the left display unit 24 is a module obtained by unitizing an optical unit and a peripheral circuit. The right display unit 22 causes an image to be displayed by the right light-guiding plate 26, and the left display unit 24 causes an image to be displayed by the left light-guiding plate 28. The right display unit 22 is provided at the right holding part 21 and the left display unit 24 is provided at the left holding part 23.

Imaging light guided by the right light-guiding plate 26 and outside light transmitted through the right light-guiding plate 26 are incident on the right eye of the user U. Similarly, the imaging light guided by the left light-guiding plate 28 and the outside light transmitted through the left light-guiding plate 28 are incident on the left eye. The imaging light from the right light-guiding plate 26 and the left light-guiding plate 28 and the outside light transmitted through the right light-guiding plate 26 and the left light-guiding plate 28 are incident on the eyes of the user U. In other words, the outside scene is visible while the image display unit 20 is mounted on the head. As a result, the user U visually recognizes an image displayed by the image display unit 20 overlapping the outside scene transmitted through the right light-guiding plate 26 and the left light-guiding plate 28.

A DP illuminance sensor 65 is arranged on the front frame 27. The DP illuminance sensor 65 is a sensor configured to receive outside light coming from in front of the user U wearing the image display unit 20. The DP illuminance sensor 65 can detect illuminance and an amount of outside light transmitted through the right light-guiding plate 26 and the left light-guiding plate 28 and incident on the eye of the user U.

A DP outer camera 61 corresponds to an imaging unit of the present disclosure. The DP outer camera 61 is provided at the front frame 27 and positioned so that the DP outer camera 61 does not block the outside light passing through the right light-guiding plate 26 and the left light-guiding plate 28. The DP outer camera 61 is a digital camera including an image capturing element such as a CCD or a CMOS, an image capturing lens, and the like, and may be a monocular camera or a stereo camera. An angle of view of the DP outer camera 61 includes at least a part of a range of the outside scene that the user U wearing the image display unit 20 visually recognizes through the right light-guiding plate 26 and the left light-guiding plate 28. The DP outer camera 61 may be a wide angle camera, or may be capable of capturing the entire outside scene visually recognized by the user U wearing the image display unit 20. CCD is an abbreviation for Charge Coupled Device, and CMOS is an abbreviation for Complementary Metal Oxide Semiconductor.

An LED indicator 67 that lights up during operation of the DP outer camera 61 is arranged on the front frame 27.

The front frame 27 includes a distance sensor 64 that detects a distance between a measurement target object located in a predetermined measurement direction and the front frame 27. The distance sensor 64 is, for example, a light reflective distance sensor using an LED, a laser diode, or the like, an infrared depth sensor, an ultrasonic distance sensor, or a laser range scanner. The distance sensor 64 may be a distance detection unit that combines image detection and sound detection, or a device that processes images obtained by stereo imaging by a camera to detect a distance. The measurement direction of the distance sensor 64 is, for example, a direction of the outside scene visually recognized by the user U through the right light-guiding plate 26 and the left light-guiding plate 28.

Each of the right display unit 22 and the left display unit 24 is coupled with the connection device 10 by the coupling cable 40. The coupling cable 40 includes an audio connector 36. A headset 30 including a right earphone 32 and a left earphone 34 constituting a stereo headphone, and a microphone 63, is coupled to the audio connector 36. The right earphone 32 and the left earphone 34 output a sound based on a sound signal output from the connection device 10. The microphone 63 is configured to collect a sound and outputs a sound signal to the connection device 10.

2. Configuration of Optical System of Image Display Unit

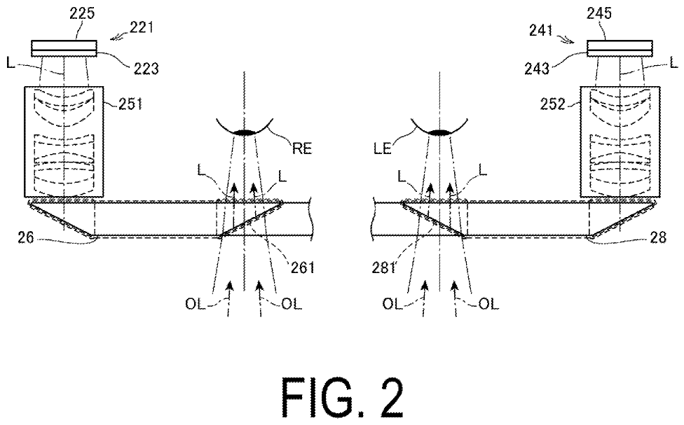

FIG. 2 is a plan view illustrating a main part of a configuration of an optical system of the image display unit 20. In FIG. 2, a left eye LE and a right eye RE of the user U are illustrated for explanation.

The right display unit 22 and the left display unit 24 are configured to be left-right symmetrical, for example.

As a configuration in which the right eye RE is caused to visually recognize an image, the right display unit 22 includes an OLED unit 221 configured to emit imaging light, and a right optical system 251 configured to guide imaging light L emitted by the OLED unit 221 to the right light-guiding plate 26. OLED is an abbreviation for Organic Light Emitting Diode.

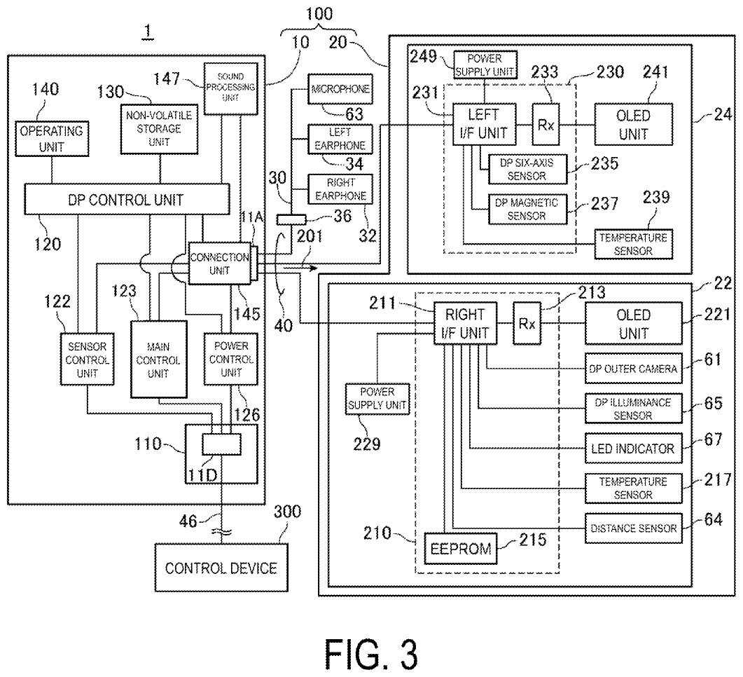

The OLED unit 221 includes an OLED panel 223 and an OLED drive circuit 225 configured to drive the OLED panel 223. The OLED panel 223 is, for example, a self-light emission type display panel in which light-emitting elements configured to emit color light of R, G, and B respectively are arranged. The OLED drive circuit 225 drives the OLED panel 223 in accordance with control of a DP control unit 120. The OLED drive circuit 225 is mounted on a substrate (not illustrated) secured to a back surface of the OLED panel 223, for example, and a temperature sensor 217 illustrated in FIG. 3 is mounted to the substrate.

The right optical system 251 converts, by a collimate lens, the imaging light L emitted from the OLED panel 223 into luminous flux in a parallel state, and causes the imaging light L to be incidence on the right light-guiding plate 26. The imaging light L is reflected by a plurality of reflection surfaces within the right light-guiding plate 26, reflected by a half mirror 261 located in front of the right eye RE, and emitted from the right light-guiding plate 26 toward the right eye RE.

As a configuration in which the left eye LE is caused to visually recognize an image, the right display unit 22 includes an OLED unit 241 configured to emit imaging light, and a left optical system 252 configured to guide the imaging light L emitted by the OLED unit 241 to the left light-guiding plate 28.

The OLED unit 241 includes an OLED panel 243, and an OLED drive circuit 245 configured to drive the OLED panel 243. The OLED panel 243 is, for example, a self-light emission type display panel in which light-emitting elements configured to emit color light of R, G, and B respectively are arranged. The OLED drive circuit 245 drives the OLED panel 243 in accordance with control of the DP control unit 120. The OLED drive circuit 245 is mounted on a substrate (not illustrated) secured to a back surface of the OLED panel 243, for example, and a temperature sensor 239 illustrated in FIG. 3 is mounted to the substrate.

The left optical system 252 converts, by a collimate lens, the imaging light L emitted from the OLED panel 243 into luminous flux in a parallel state, and causes the imaging light L to be incidence on the left light-guiding plate 28. The imaging light L is reflected by a plurality of reflection surfaces within the left light-guiding plate 28, reflected by the half mirror 261 located in front of the left eye LE, and emitted from the left light-guiding plate 28 toward the left eye LE.

The HMD 100 functions as a transmissive display device. Namely, the imaging light L reflected by the half mirror 261 and outside light OL having passed through the right light-guiding plate 26 enter the right eye RE of the user U. The imaging light L reflected by a half mirror 281 and the outside light OL having passed through the half mirror 281 enter the left eye LE. The HMD 100 allows the imaging light L of an internally processed image and the outside light OL to enter the eyes of the user U in an overlapped manner. This allows the user U to see the outside scene through the right light-guiding plate 26 and the left light-guiding plate 28, enabling the image due to the imaging light L to be visually recognized in a manner overlapped with the outside scene. Each of the half mirrors 261 and 281 is an image extracting unit configured to reflect imaging light output by each of the right display unit 22 and the left display unit 24 and extract an image, and configures a display unit.

3. Control System of HMD

FIG. 3 is a block diagram of the display system 1, particularly illustrating a configuration of the HMD 100 in detail.

In the image display unit 20, the right display unit 22 includes a right display unit substrate 210. On the right display unit substrate 210, a right I/F unit 211 coupled to the coupling cable 40, a reception unit 213 that receives data input from the connection device 10 via the right I/F unit 211, and an EEPROM 215 are mounted. The right I/F unit 211 couples the reception unit 213, the EEPROM 215, the temperature sensor 217, the DP outer camera 61, the distance sensor 64, the DP illuminance sensor 65, and the LED indicator 67 to the connection device 10. The reception unit 213 couples the OLED unit 221 to the connection device 10.

The left display unit 24 includes a left display unit substrate 230. On the left display unit substrate 230, a left I/F unit 231 coupled to the coupling cable 40, a reception unit 233 that receives data input from the connection device 10 via the left I/F unit 231 are mounted. The left display unit substrate 230 is mounted with a DP six-axis sensor 235 and a DP magnetic sensor 237.

The left I/F unit 231 couples the reception unit 233, the DP six-axis sensor 235, the DP magnetic sensor 237, and the temperature sensor 239 to the connection device 10. The reception unit 233 couples the OLED unit 241 to the connection device 10.

In the descriptions and figures of the present exemplary embodiment, I/F is an abbreviation for interface. EEPROM is an abbreviation for Electrically Erasable Programmable Read-Only Memory. The reception unit 213 and the reception unit 233 may be described as Rx213 and Rx233, respectively.

The EEPROM 215 is configured to store various types of data in a non-volatile manner. The EEPROM 215 stores, for example, data about light-emitting properties and display properties of the OLED units 221 and 241 provided in the image display unit 20, and data about a property of a sensor provided in the right display unit 22 or the left display unit 24. Specifically, parameters regarding gamma correction of the OLED units 221 and 241, data used to compensate for detection values of the temperature sensors 217 and 239, and the like, are stored so as to be readable by the DP control unit 120.

The DP outer camera 61 performs capturing in accordance with a signal input via the right I/F unit 211 and outputs a captured image to the right I/F unit 211. The DP illuminance sensor 65 is configured to receive the outside light and output a detection value corresponding to an amount of the received light or intensity of the received light. The LED indicator 67 is configured to light up in accordance with a control signal or a driving current input via the right I/F unit 211.

The temperature sensor 217 is configured to detect a temperature of the OLED unit 221, and outputs a voltage value or a resistance value corresponding to the detected temperature as a detection value.

The distance sensor 64 is configured to output a signal indicating detection results of distance detection to the connection device 10 via the right I/F unit 211.

The reception unit 213 is configured to receive video data for displaying transmitted from the connection device 10 via the right I/F unit 211, and output the video data to the OLED unit 221. The OLED unit 221 displays video based on the video data transmitted by the connection device 10.

The reception unit 233 is configured to receive video data for displaying transmitted from the connection device 10 via the left I/F unit 231, and output the video data to the OLED unit 241. The OLED unit 221 and 241 displays video based on the video data transmitted by the connection device 10.

The DP six-axis sensor 235 is a motion sensor including a three-axis acceleration sensor and a three-axis gyro sensor. The DP magnetic sensor 237 is a three-axis geomagnetic sensor, for example. The DP six-axis sensor 235 and the DP magnetic sensor 237 may each be an IMU in which each of the sensors described above is modularized, or may be a module in which the DP six-axis sensor 235 and the DP magnetic sensor 237 are integrally modularized. IMU is an abbreviation for Inertial Measurement Unit. The temperature sensor 239 detects a temperature of the OLED unit 241. The DP six-axis sensor 235, the DP magnetic sensor 237, and the temperature sensor 239 each output a detection value to the connection device 10.

Each component of the image display unit 20 operates with power supplied from the connection device 10 via the coupling cable 40. The image display unit 20 includes a power supply unit 229 on the right display unit 22, and a power supply unit 249 on the left display unit 24. The power supply unit 229 is configured to distribute and supply the power supplied by the connection device 10 via the coupling cable 40 to each part of the right display unit 22 including the right display unit substrate 210. The power supply unit 249 is configured to distribute and supply the power supplied by the connection device 10 via the coupling cable 40 to each part of the left display unit 24 including the left display unit substrate 230. The power supply units 229 and 249 may each include a conversion circuit or the like configured to convert a voltage.

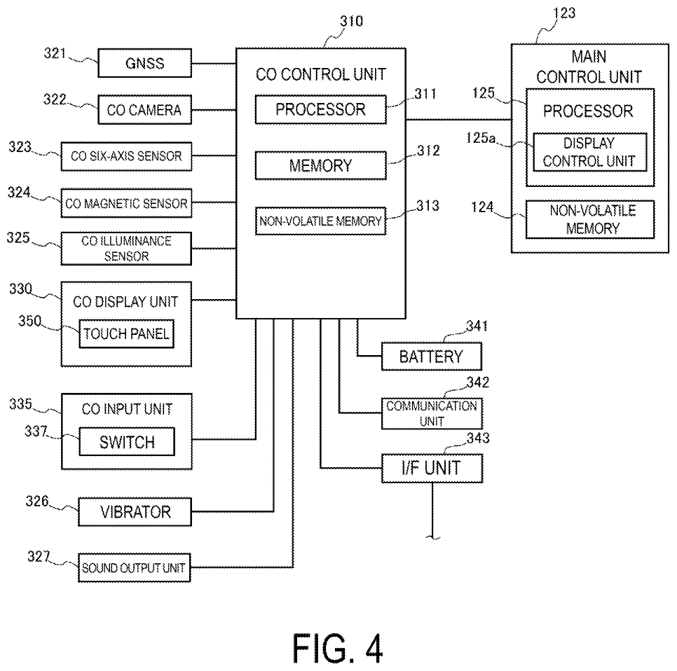

The connection device 10 includes an I/F unit 110, the DP control unit 120, a sensor control unit 122, a main control unit 123, a power control unit 126, a non-volatile storage unit 130, an operating unit 140, a connection unit 145, and a sound processing unit 147. Details of the main control unit 123 will be described with reference to FIG. 4.

The I/F unit 110 includes the connector 11D and an interface circuit configured to execute communication protocols conforming to respective communication standards by the connector 11D. The I/F unit 110 is, for example, an interface substrate on which the connector 11D and the interface circuit are mounted. The I/F unit 110 may include an interface for a memory card capable of being coupled with an external storage device or storage medium, or the like, or the I/F unit 110 may include a radio communication interface.

The DP control unit 120 includes a processor such as a CPU or a microcomputer, and this processor is configured to execute a program to control each component of the connection device 10. The DP control unit 120 may include a RAM configuring a work area for the processor. RAM is an abbreviation for Random Access Memory.

The DP control unit 120 is coupled to the non-volatile storage unit 130, the operating unit 140, the connection unit 145, and the sound processing unit 147. The non-volatile storage unit 130 is a ROM configured to store a program to be executed by the DP control unit 120, and data in a non-volatile manner. ROM is an abbreviation for Read Only Memory.

The sensor control unit 122 operates the respective sensors included in the image display unit 20. Here, the respective sensors refer to the DP outer camera 61, the distance sensor 64, the DP illuminance sensor 65, the temperature sensor 217, the DP six-axis sensor 235, DP the magnetic sensor 237, and the temperature sensor 239. The respective sensors include at least one or more of the DP outer camera 61, the DP illuminance sensor 65, the DP six-axis sensor 235, and the DP magnetic sensor 237. The sensor control unit 122 is configured to perform setting and initialization of a sampling period of each sensor according to control of the DP control unit 120, and execute energization to each sensor, transmission of control data, acquisition of detection values and the like, in correspondence to the sampling period of each sensor.

The sensor control unit 122 outputs detection data indicative of a detection value and a detection result of each sensor to the I/F unit 110 at preset timing. The sensor control unit 122 may include an A/D converter to convert analog signals into digital data. In this case, the sensor control unit 122 converts analog signals of detection values and detection results obtained from the sensors of the image display unit 20 into detection data and outputs the detection data. The sensor control unit 122 may acquire digital data of detection values and detection results from the sensors of the image display unit 20, perform a conversion of data format, adjustment of output timing, and the like, and output detection data to the I/F unit 110.

By operation of the sensor control unit 122, the control device 300 coupled to the I/F unit 110 can acquire a detection value of each sensor of the HMD 100, and a captured image of the DP outer camera 61.

The sensor control unit 122 may output results obtained by an arithmetic operation based on detection value of each sensor described above, as detection data. For example, the sensor control unit 122 may be configured to integrally process detection values and detection results of a plurality of sensors, and to function as a so-called sensor fusion processing unit. In this case, the sensor control unit 122 may generate detection data for a virtual sensor not included in the respective sensors of the image display unit 20 by sensor fusion. For example, the sensor control unit 122 may output, as detection data, trajectory data indicating a trajectory along which the image display unit 20 moves, coordinate data indicating a position of the image display unit 20 in a three-dimensional space, and directional data indicating a direction of the image display unit 20. Here, the coordinate data may be data indicating relative coordinates with respect to a position of the connection device 10, or may be data indicating a position with respect to a reference position set in a space in which the image display unit 20 is present. The direction data may be data indicating a direction with respect to a position or a direction of the connection device 10, or may be data indicating a direction with respect to a reference position set in the space in which the image display unit 20 is present.

The sensor control unit 122 executes a communication protocol to and from a device coupled to the connector 11D by the USB cable 46, and outputs detection data.

The sensor control unit 122 and the main control unit 123 may be realized by cooperation of software and hardware by a processor executing a program. That is, the sensor control unit 122 and the main control unit 123 are configured by a processor to execute a program to execute the operations described above. In this example, the sensor control unit 122 and the main control unit 123 may be realized by a processor constituting the DP control unit 120 executing a program. In other words, the processor may function as the DP control unit 120, the main control unit 123 and the sensor control unit 122 by executing the program. Here, the processor can be paraphrased as a computer. Each of the sensor control unit 122 and the main control unit 123 may include a work memory for executing data processing, and may execute processing by using a memory of the DP control unit 120.

Further, the main control unit 123 and the sensor control unit 122 may include programmed hardware such as DSP, FPGA. The sensor control unit 122 and the main control unit 123 may be integrated to be configured of an SoC-FPGA. DSP is an abbreviation for Digital Signal Processor, FPGA is an abbreviation for Field Programmable Gate Array, and SoC is an abbreviation for System-on-a-Chip.

The power control unit 126 is a circuit that is coupled to the connector 11D, and based on power supplied from the connector 11D, supplies power to each component of the connection device 10 and to the image display unit 20.

The operating unit 140 is configured to detect an operation on a switch and the like included in the connection device 10 and outputs data indicating an operation content to the DP control unit 120.

The sound processing unit 147 is configured to generate a sound signal according to sound data that is input from the DP control unit 120, and output the sound signal to the connection unit 145. This sound signal is output from the connection unit 145 to the right earphone 32 and the left earphone 34 via the audio connector 36. The sound processing unit 147 is configured to generate sound data of the sound collected by the microphone 63, and output the sound data to the DP control unit 120. The sound data output by the sound processing unit 147 may be processed by the sensor control unit 122 in the same manner as detection data of the sensor included in the image display unit 20.

4. Configuration of Control Device

FIG. 4 is a block diagram of the control device 300 and the main control unit 123.

First, the control device 300 will be described. The control device 300 includes a CO control unit 310. The CO control unit 310 includes a processor 311, a memory 312, and a non-volatile memory 313. The processor 311 is configured with a CPU, a microcomputer, a DSP, and the like, and is configured to execute a program to control each unit of the control device 300. The memory 312 forms a work area of the processor 311. The non-volatile memory 313 is configured with a semiconductor memory device or the like, and stores a program executed by the processor 311, and various kinds of data to be processed by the processor 311. For example, the non-volatile memory 313 stores an operating system as basic control programs to be executed by the processor 311, and application programs operating on the operating system. The non-volatile memory 313 is configured to store data processed during execution of the application program, data of processing results, and the like. The operating system is abbreviated as OS below.

The CO control unit 310 may be an SoC integrating the processor 311, the memory 312, and the non-volatile memory 313.

A GNSS 321, a CO camera 322, a CO six-axis sensor 323, a CO magnetic sensor 324, a CO illuminance sensor 325, a vibrator 326, a sound output unit 327, a CO display unit 330 and a CO input unit 335 are coupled to the CO control unit 310.

The GNSS 321 uses a satellite positioning system to perform positioning, and outputs a position of the control device 300 to the CO control unit 310. GNSS is an abbreviation for Global Navigation Satellite System.

The CO camera 322 is a digital camera provided at a main body of the control device 300, and is arranged adjacent to the touch panel 350, for example, and captures a direction facing the touch panel 350. The CO camera 322 is configured to capture an image in accordance with a control by the CO control unit 310, and output captured image to the CO control unit 310.

The CO six-axis sensor 323 is a motion sensor including a three-axis acceleration sensor and a three-axis gyro sensor, and outputs detection data indicating detection values to the CO control unit 310. The CO magnetic sensor 324 is, for example, a three-axis geomagnetic sensor, and outputs detection data indicating detection values to the CO control unit 310. The CO six-axis sensor 323 and the CO magnetic sensor 324 may each be an IMU in which each of the sensors described above is modularized, or may be a module in which the CO six-axis sensor 323 and the CO magnetic sensor 324 may be integrally modularized.

The CO illuminance sensor 325 is configured to receive the outside light and output detection data indicating a detection value corresponding to an amount of the received light or an intensity of the received light to the CO control unit 310.

The vibrator 326 generates vibration in accordance with control of the CO control unit 310, and causes a part or all of the main body of the control device 300 to vibrate. The vibrator 326 is configured to include, for example, an eccentric weight and a motor.

The sound output unit 327 is provided with a speaker, and outputs sound from the speaker according to the control of the CO control unit 310. The sound output unit 327 may include an amplifier that amplifies a sound signal output by the CO control unit 310 and outputs the amplified sound signal to a speaker. When the CO control unit 310 is configured to output digital sound data, the sound output unit 327 may include a D/A converter that converts digital sound data to an analog sound signal.

The CO display unit 330 has the touch panel 350, and displays characters and images on the touch panel 350 in accordance with the control of the CO control unit 310. The touch panel 350 is an example of the operating surface of the present disclosure.

The CO input unit 335 is configured to detect operations on the switch 337, and output operation data indicating the detected operations to the CO control unit 310. The switch 337 is a hardware switch such as, for example, a power switch or a volume adjustment switch of the control device 300. The switch 337 may be a contact or non-contact sensor, and for example, may be a fingerprint sensor or the like embedded in the touch panel 350. Alternatively, the switch 337 may be a software switch formed utilizing a part or all of the touch panel 350.

A battery 341, a communication unit 342, and an I/F unit 343 are coupled to the CO control unit 310.

The battery 341 is a secondary battery built into the main body of the control device 300, and supplies power to each unit of the control device 300. The battery 341 may include a control circuit (not illustrated) that controls power output and charging to the secondary battery.

The communication unit 342 supports a wireless communication protocol such as Bluetooth or Wi-Fi, and performs wireless communication with a device external to the display system 1. Bluetooth and Wi-Fi are registered trademarks. The communication unit 342 may be configured to perform mobile data communication using a mobile communication network such as LTE or a fifth-generation mobile communication system. LTE is a registered trademark.

The I/F unit 343 includes a connector (not illustrated) to which a data communication cable is coupled, and an interface circuit configured to execute communication protocols conforming to respective communication standards by the connector. For example, the I/F unit 343 includes a connector and an interface circuit conforming to a USB standard and transmits and receives data through the USB cable 46.

In the present exemplary embodiment, the control device 300 transmits video data to the HMD 100 via the I/F unit 343, and receives detection data of the sensors from the HMD 100. The control device 300 supplies power to the HMD 100 via the I/F unit 343.

A configuration will be illustrated in which, the I/F unit 343 of the present exemplary embodiment includes a USB interface, and the control device 300 transmits and receives data with the HMD 100 using the USB cable 46 coupled to the I/F unit 343.

The control device 300 may perform wireless data communication with the HMD 100 by the communication unit 342, for example.

The main control unit 123 includes a non-volatile memory 124 and a processor 125.

The non-volatile memory 124 is configured with a semiconductor memory device or the like, and stores a program executed by the processor 125, and various kinds of data to be processed by the processor 125.

The processor 125 is configured with a CPU, a microcomputer, a DSP, and the like, and is configured to execute a program to control the connection device 10.

The main control unit 123 includes a display control unit 125a as a function block.

The display control unit 125a is configured to execute various kinds of processing for the image display unit 20 to display an image based on display data input to the I/F unit 110. The display data includes, for example, video data. In the present exemplary embodiment, video data is transmitted through the connector 11D constituted by a USB-TypeC connector in the alternate mode of the USB-TypeC. For example, the display control unit 125a is configured to execute various kinds of processing such as cutting out of a frame, resolution conversion, scaling, intermediate frame generation, and frame rate conversion. The display control unit 125a is configured to output video data corresponding to the OLED units 221 and 241 to the connection unit 145. The video data input to the connection unit 145 is transmitted as a video signal 201 from the connector 11A to the right I/F unit 211 and the left I/F unit 231. The display control unit 125a causes the right display unit 22 and the left display unit 24 to display an image in accordance with display data transmitted by the control device 300.

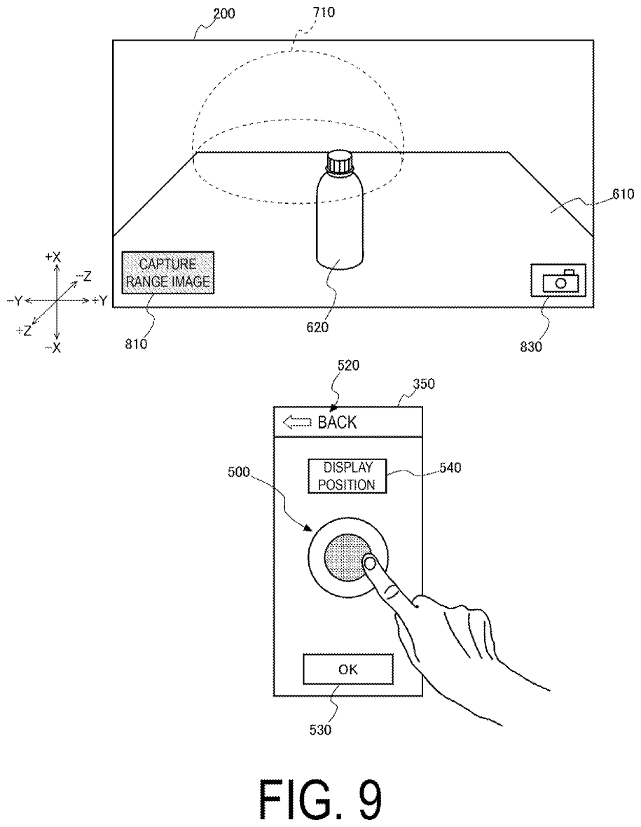

A region in which an image is displayed by the right display unit 22 and the left display unit 24 of the image display unit 20 is referred to as a display region 200. The display region 200 is a range in which the user U can visually recognize the imaging light L emitted by the OLED panels 223 and 243 and incident on the right eye and left eye of the user U by the right light-guiding plate 26 and the left light-guiding plate 28. As illustrated in FIG. 9, the display region 200 is a three-dimensional region having three-axis directions of up-down, left-right, and front-back. In the following, an upward direction of the display region 200 as viewed by the user U is referred to as a +X direction, a downward direction is referred to as a −X direction, a left direction is referred to as a −Y direction, and a right direction is referred to as a +Y direction. In addition, a front direction, which is a depth direction of the display region 200, is referred to as a +Z direction, and a back direction is referred to as a −Z direction.

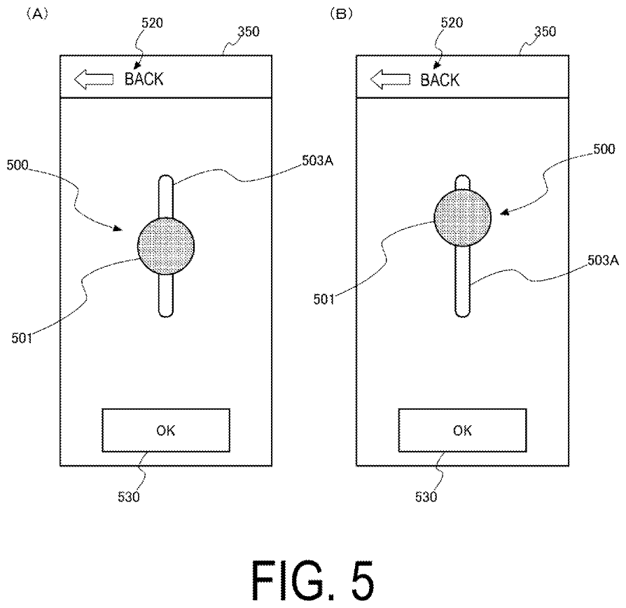

FIGS. 5 to 8 are views illustrating a virtual joystick controller 500 displayed on the touch panel 350. The virtual joystick controller 500 will be described with reference to FIGS. 5 to 8.

The virtual joystick controller 500 is displayed on the touch panel 350, which is the operating surface, by the control of the CO control unit 310.

The virtual joystick controller 500 is an operation image for accepting operation by the user U, which is an operation image with which operation equivalent to operation that can be accepted by an actual joystick controller can be accepted. In particular, with the virtual joystick controller 500, directional input can be accepted. The virtual joystick controller 500 includes a plurality of display modes, and a direction that can be accepted can be changed in response to the display mode. Specifically, the virtual joystick controller 500 includes an operator image 501, display position of which on the touch panel 350 is changed by operation by the user U, and has three display modes since a limitation is provided on a direction in which the display position of the operator image 501 can be changed.

The virtual joystick controller 500 includes the three display modes of a first display mode, a second display mode, and a third display mode. In response to a display image that the main control unit 123 causes to display in the display region 200, the CO control unit 310 causes the virtual joystick controller 500 to be displayed in any one form of the first display mode, the second display mode, and the third display mode.

Specifically, when the display image displayed in the display region 200 is an image for accepting input of two directions, such as the up-down direction and the left-right direction, the CO control unit 310 causes the virtual joystick controller 500 in the first display mode or the second display mode to be displayed on the touch panel 350. Further, when the display image displayed in the display region 200 is an image for accepting input of all the directions, the CO control unit 310 causes the virtual joystick controller 500 in the third display mode to be displayed on the touch panel 350.

FIG. 5 is a diagram illustrating the virtual joystick controller 500 in the first display mode. In particular, FIG. 5A illustrates a case in which the operator image 501 is positioned at a center of a slider bar 503A, and FIG. 5B illustrates a case in which the operator image 501 is positioned on an upper side of the slider bar 503A.

The virtual joystick controller 500 in the first display mode includes the operator image 501 operated by the user U, and the slider bar 503A that indicates a range of movement of the operator image 501. The operator image 501 is an image, display position of which is changed in response to operation by the user U. A shape of the operator image 501 of the present exemplary embodiment is a precise circle, but is not limited to the precise circle, and it is sufficient that a shape that is easy to be operated by the user U is used. The slider bar 503A has a portrait shape extending in the up-down direction, which is a longitudinal direction of the touch panel 350, and indicates a range of movement through which the operator image 501 can be moved by operation by the user U. In other words, when the operator image 501 is moved to an upper limit of an upper side of the slider bar 503A, the operator image 501 cannot be moved to the upper side any more, and when the operator image 501 is moved to a lower limit of a lower side of the slider bar 503A, the operator image 501 cannot be moved to the lower side any more.

Further, when a tablet PC is used as the control device 300, a ratio occupied by the operator image 501 in the touch panel 350 of the tablet PC is small, and when a smart phone is used as the control device 300, a ratio occupied by the operator image 501 in the touch panel 350 of the smart phone is large.

The virtual joystick controller 500 in the first display mode is an aspect in which the operator image 501 can be moved only in the up-down direction, which is an extension direction of the slider bar 503A. The up-down direction corresponds to a first direction of the present disclosure. The CO controller 310 acquires information of a display image that the image display unit 20 causes to display in the display region 200 from the main control unit 123, and determines a display aspect of the virtual joystick controller 500 based on the acquired information. For example, when a display image is an image for accepting input of the up-down direction, and performing processing corresponding to the accepted input, or changing the display mode of the display image, the CO control unit 310 causes the virtual joystick controller 500 in the first display mode to be displayed on the touch panel 350.

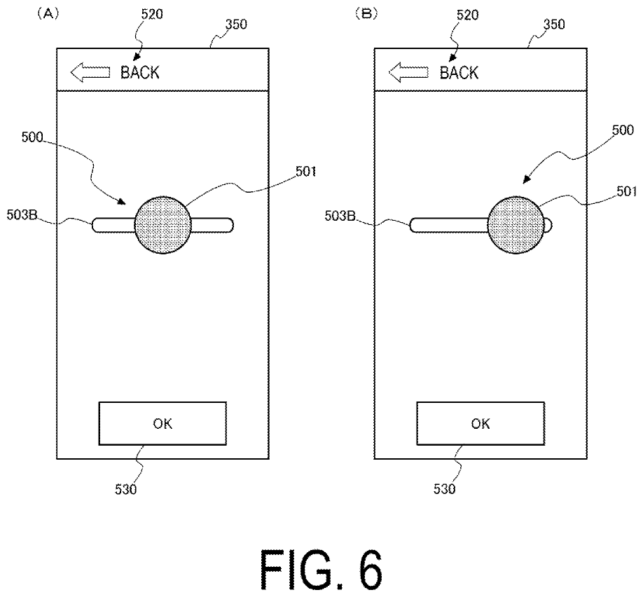

FIG. 6 is a diagram illustrating the virtual joystick controller 500 in the first display mode. In particular, FIG. 6A illustrates a case in which the operator image 501 is positioned at a center of a slider bar 503B, and FIG. 6B illustrates a case in which the operator image 501 is positioned on a right side of the slider bar 503B.

The virtual joystick controller 500 in the second display mode includes the operator image 501 operated by the user U, and the slider bar 503B that indicates a range through which the operator image 501 can be moved. A shape of the operator image 501 of the second display mode is also a precise circle, but is not limited to the precise circle, and it is sufficient that a shape that is easy to be operated by the user U is used. The slider bar 503B has a landscape shape extending in the left-right direction, which is a short direction of the touch panel 350, and indicates a range of movement through which the operator image 501 can be moved by operation by the user U. In other words, when the operator image 501 is moved to a left end of the slider bar 503B, the operator image 501 cannot be moved to the left side any more, and when the operator image 501 is moved to a right end of the slider bar 503B, the operator image 501 cannot be moved to the right side any more.

The virtual joystick controller 500 in the second display mode is an aspect in which the operator image 501 can be moved only in the left-right direction, which is the extension direction of the slider bar 503B. The left-right direction corresponds to a second direction of the present disclosure. The CO controller 310 acquires information of a display image that the image display unit 20 causes to display in the display region 200 from the main control unit 123, and determines a display aspect of the virtual joystick controller 500 based on the acquired information. For example, when a display image is an image for accepting input of the left-right direction and performing processing corresponding to the accepted input, or changing the display mode of the display image, the CO control unit 310 causes the virtual joystick controller 500 in the second display mode to be displayed on the touch panel 350.

Further, the CO control unit 310 may determine posture of the control device 300 based on detection data input from the CO six-axis sensor 323, and change the display of the virtual joystick controller 500 in response to the determined posture.

For example, assume that the user U, while holding the control device 300 in a hand, rotates the control device 300, and holds the control device 300 again so that a short direction of the touch panel 350 is parallel to a vertical direction. In this case, the CO control unit 310 changes the display of the virtual joystick controller 500 in the first display mode so that the extension direction of the slider bar 503A is the short direction of the touch panel 350. In addition, the CO control unit 310 changes the display of the virtual joystick controller 500 in the second display mode so that the extension direction of the slider bar 503B is the longitudinal direction of the touch panel 350.

Also, FIG. 5 illustrates the case in which the extension direction of the slider bar 503A is the longitudinal direction of the touch panel 350, and FIG. 6 illustrates the case in which the extension direction of the slider bar 503B is the short direction of the touch panel 350, however, the extension directions of the slider bar 503A and the slider bar 503B are not limited to the longitudinal direction and the short direction of the touch panel 350. For example, the slider bar 503A and the slider bar 503B may be displayed so as to be parallel to a diagonal direction of the touch panel 350.

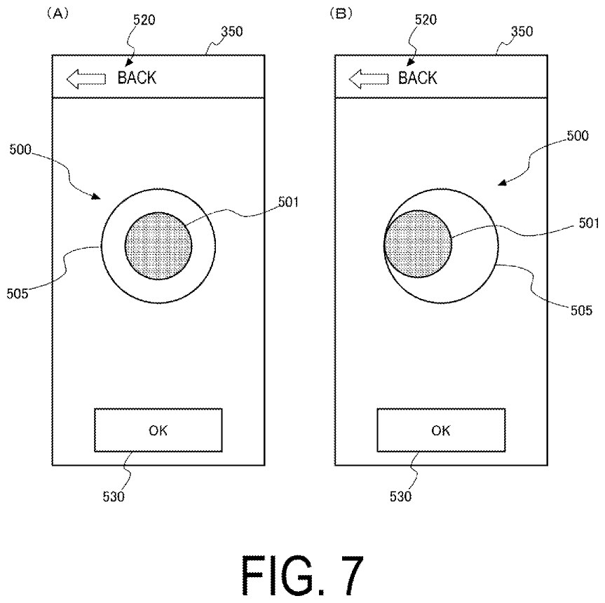

FIG. 7 is a diagram illustrating a configuration of the virtual joystick controller 500 in the third display mode.

The virtual joystick controller 500 in the third display mode includes the operator image 501 operated by the user U, and a range image 505 that indicates a range through which the operator image 501 can be moved. A shape of each of the operator image 501 and the range image 505 is a precise circle, and a radius of the range image 505 is greater than a radius of the operator image 501.

Unlike the virtual joystick controller 500 in the first and second display modes, the virtual joystick controller 500 in the third display mode is not limited in directions in which the operator image 501 can be moved, and the operator image 501 can be moved in all 360 degrees within a range of the range image 505.

FIG. 7A illustrates a display position of the operator image 501 when the operator image 501 is positioned at a center of the range image 505, and before operation by the user U is accepted. Further, FIG. 7B illustrates a display position of the operator image 501 when the operator image 501 is positioned on a left side of the range image 505, and before operation by the user U is accepted. The CO control unit 310 identifies a direction input by the user U, based on the display position of the operator image 501 before being operated, and a display position of the operator image 501 after being operated. In other words, the CO control unit 310, with the display position of the operator image 501 before being operated being a reference, identifies a direction in which the operator image 501 has moved from the reference position, and identifies the direction input by the user U.

Further, in the virtual joystick controller 500 in the third display mode, operations on the operator image 501 include operations for rotating the operator image 501 right or left, for rotating to the left, for tapping, and for long pressing. For these operations, the CO control unit 310 identifies a direction input by the user U based on a display position of the operator image 501 before being operated, and a display position of the operator image 501 after being operated.

The CO controller 310 acquires information of a display image that the image display unit 20 causes to display in the display region 200 from the main control unit 123, and determines a display aspect of the virtual joystick controller 500 based on the acquired information.

For example, when a display image is an image for accepting input of the four directions of the up-down and left-right, and performing processing corresponding to the accepted input, or changing the display mode of the display image, the CO control unit 310 causes the virtual joystick controller 500 in the third display mode to be displayed on the touch panel 350. The user U can operate the operator image 501 to move, for example, a display position in the display region 200 of a capture range image 710 illustrated in FIG. 9 described below, in the ±X directions, the ±Y directions, and the ±Z directions.

In the case of the virtual joystick controller 500 in the third display mode, the user U touches the display position of the virtual joystick controller 500 with a finger, and moves the touching finger in a direction to input without moving the touching finger away from the touch panel 350. Thus, the number of times that the user U checks the touch panel 350 can be reduced compared to a case where a position of a key is checked each time operation is performed, as with a cross key. Accordingly, operability for the user U wearing the image display unit 20 on the head, and visually recognizing the touch panel 350 through the image display unit 20 can be improved.

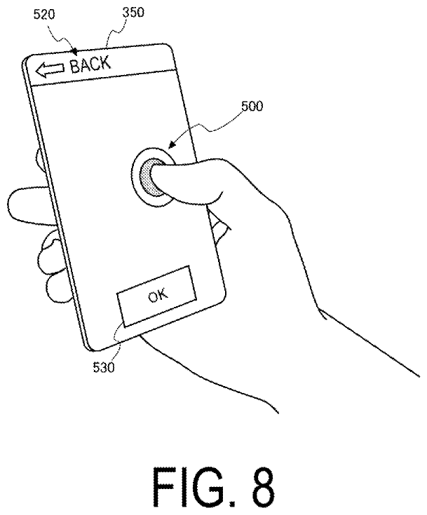

FIG. 8 is a diagram illustrating a state in which the user U holds the control device 300 with one hand, and particularly illustrates a state in which the virtual joystick controller 500 is displayed at a position touched by a thumb of the user U.

FIGS. 5 to 7 illustrate the case in which the virtual joystick controller 500 is displayed at a center of the screen of the touch panel 350. FIG. 8 illustrates a case in which, with a position of the touch panel 350 at which the finger of the user U, which is an indicator, is first touched being a reference, the virtual joystick controller 500 is displayed.

The CO control unit 310 displays the virtual joystick controller 500 with a coordinate position of the touch panel 350 indicated by a signal input from the touch panel 350 as a center. For example, the virtual joystick controller 500 is caused to be displayed so that a center of the operator image 501 is displayed at the coordinate position of the touch panel 350.

A size of the hand of the user U has a personal difference, and when the virtual joystick controller 500 is caused to be displayed at the center of the screen of the touch panel 350, operation by one hand may be difficult. Thus, by displaying the virtual joystick controller 500, with the position of the touch panel 350 at which the finger contact of the user U has been detected being a reference, operability with one hand for the virtual joystick controller 500 can be improved. Further, the user U also touches the touch panel 350 with the finger, and moves the touching finger in a direction to input without moving the touching finger away from the touch panel 350. Because the virtual joystick controller 500 is displayed at the position where the user U touched, the user U can perform operation by touch-typing without looking at the touch panel 350.

As illustrated in FIGS. 5 to 8, in addition to the virtual joystick controller 500, a BACK button 520 and an OK button 530 are displayed on the touch panel 350. The BACK button 520 is a button for accepting operation for returning to a previous screen of the currently displayed screen. The OK button is a button for accepting operation for fixing display of a display image that has been changed by operation of the virtual joystick controller 500, or fixing setting of the DP outer camera 61.

Operating targets that can be operated by the above-described virtual joystick controller 500 including the first display mode, the second display mode, and the third display mode include a display image displayed in the display region 200 by the image display unit 20, and setting for imaging by the DP outer camera 61. When a preset operation of the virtual joystick controller 500 is accepted, the CO control unit 310 switches the operating target to the display image or the DP outer camera 61. For example, when operation of tapping the operator image 501 of the virtual joystick controller 500 once is accepted, the CO control unit 310 sets the operating target of the virtual joystick controller 500 to the display image. Further, when operation of tapping the operator image 501 twice is accepted, the CO control unit 310 sets the operating target of the virtual joystick controller 500 to the DP outer camera 61. In this case, the CO control unit 310 outputs information of the operation accepted by the virtual joystick controller 500 to the main control unit 123.

Furthermore, the CO control unit 310 may change the operating target of the virtual joystick controller 500, based on an application program executed by the main control unit 123, and the display image displayed by the image display unit 20. For example, when the image display unit 20 displays the display image in the display region 200, the CO control unit 310 changes the operating target of the virtual joystick controller 500 to the display image. In addition, when a notification that a camera application is activated is received from the main control unit 123, the CO control unit 310 changes the operating target of the virtual joystick controller 500 to the DP outer camera 61.

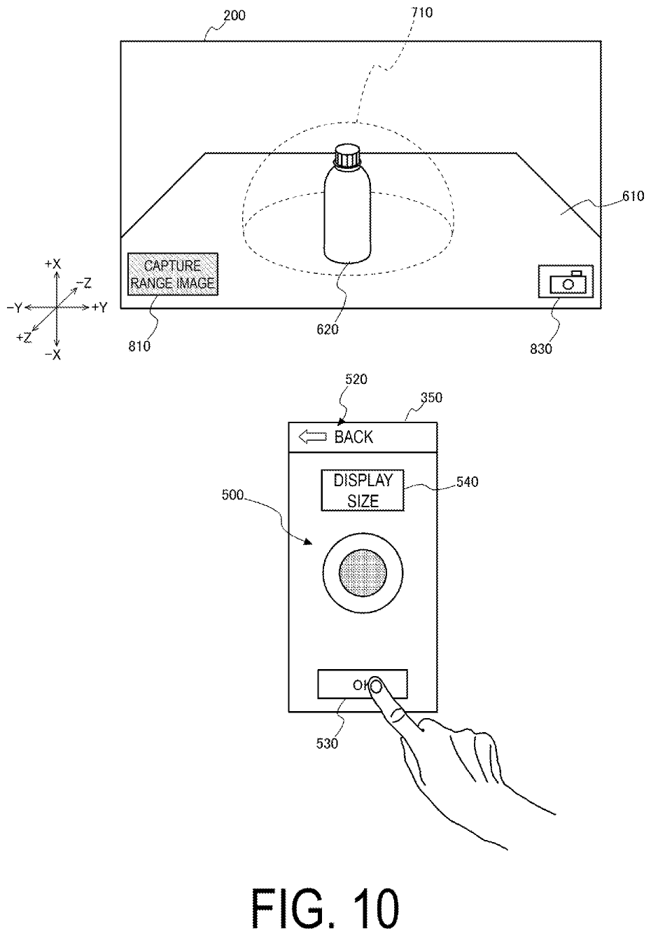

FIGS. 9 and 10 are explanatory diagrams explaining a case in which a display image displayed by the image display unit 20 is operated by the virtual joystick controller 500.

Hereinafter, a case is described in which the user U operates the virtual joystick controller 500 to move the capture range image 710, which is an example of the display image, to a range where an image is to be captured by the DP outer camera 61. The capture range image 710 is an image indicating a range of a captured image captured by the DP outer camera 61, to be captured as a capture image. Note that, in the present exemplary embodiment, a case is described in which the capture range image 710 is used to change the range of the captured image by the DP outer camera 61 to be captured as the capture image, but indeed, by operating the virtual joystick controller 500, an angle of view and the like of the DP outer camera 61 may be adjusted to change an imaging range of the DP outer camera 61.

In FIG. 9 and FIG. 10, a desk 610 and a bottle 620 are visible as objects in a real space to the user U wearing the image display unit 20 on the head. Further, the user U can visually recognize the capture range image 710 as a display image displayed by the image display unit 20. The capture range image 710, indicated by broken lines in FIGS. 9 and 10, is an image of a hemispherical shape, and is a three-dimensional image having regions in the directions of the X-, Y-, and Z-axes, which are three axes of the display region 200.

In addition to the capture range image 710, a first icon 810 and a second icon 830 are displayed in the display region 200. The first icon 810 is an icon indicating that an operating target of the virtual joystick controller 500 is the capture range image 710, which is a display image. The second icon 830 is an icon indicating that an operating target of the virtual joystick controller 500 is the DP outer camera 61. In FIGS. 9 and 10, a state is indicated in which the first icon 810 is selected and lights up or flashes, by hatching a display region of the first icon 810.

In addition to the virtual joystick controller 500, the BACK button 520, and the OK button 530, a guide display 540 are displayed on the touch panel 350 of the control device 300. An operation content by the virtual joystick controller 500 is displayed in the guide display 540. For example, when the operating target by the virtual joystick controller 500 is the display image, a display position or display size is displayed as the operation content in the guide display 540.

The display position indicates that the operation of the virtual joystick controller 500 is operation for changing the display position of the capture range image 710.

The display size indicates that the operation of the virtual joystick controller 500 is operation for expanding or contracting a size that is the display size of the capture range image 710.

Switching of the operation content of the virtual joystick controller 500 can be performed by, for example, a touch operation on the guide display 540. When the touch operation on the guide display 540 is detected in a state in which “DISPLAY POSITION” is displayed in the guide display 540 of the touch panel 350, the CO control unit 310 changes the operation content of the virtual joystick controller 500 to “DISPLAY SIZE”. At this time, the display of the guide display 540 is changed to the display size. Further, when the touch operation on the guide display 540 is detected in a state in which “DISPLAY SIZE” is displayed in the guide display 540 of the touch panel 350, the CO control unit 310 changes the operation content of the virtual joystick controller 500 to “DISPLAY POSITION”. At this time, the display of the guide display 540 is also changed to the display position.

In the display example of the display region 200 illustrated in FIG. 9, the capture range image 710 is displayed at a position away from the bottle 620, and even when a captured image in a range indicated by the capture range image 710 illustrated in FIG. 9 is captured, an entire image of the bottle 620 cannot be captured. Thus, the user U operates the operator image 501 of the virtual joystick controller 500 to move the capture range image 710 in the ±X, ±Y, and ±Z directions to change the display position such that the capture range image 710 covers the entire bottle 620 to be imaged, as illustrated in FIG. 10.

For example, assume that the user U has moved the operator image 501 of the virtual joystick controller 500 in the upward direction. Upon detecting the operation of moving the operator image 501 in the upward direction, the CO control unit 310 outputs an operation signal corresponding to the detected operation to the main control unit 123. This moves the capture range image 710 in the +X direction, which is the upward direction of the display region 200.

Assume that the user U has moved the operator image 501 of the virtual joystick controller 500 in the downward direction. Upon detecting the operation of moving the operator image 501 in the downward direction, the CO control unit 310 outputs an operation signal corresponding to the detected operation to the main control unit 123. This moves the capture range image 710 in the −X direction, which is the downward direction of the display region 200.

Hereinafter, similarly, upon detecting operation of moving the operator image 501 in the left direction or the right direction, the CO control unit 310 outputs an operation signal corresponding to the detected operation to the main control unit 123. This moves the capture range image 710 in the −Y direction, which is the left direction of the display region 200, or the +Y direction, which is the right direction.

Further, assume that the user U has rotated the operator image 501 of the virtual joystick controller 500 right. Upon detecting the operation of rotating the operator image 501 right, the CO control unit 310 outputs an operation signal corresponding to the detected operation to the main control unit 123. This moves the capture range image 710 in the +Z direction, which is the front direction of the display region 200.

Similarly, assume that the user U has rotated the operator image 501 of the virtual joystick controller 500 left. Upon detecting the operation of rotating the operator image 501 left, the CO control unit 310 outputs an operation signal corresponding to the detected operation to the main control unit 123. This moves the capture range image 710 in the −Z direction, which is the back direction of the display region 200.

Further, the CO control unit 310 may determine posture of the control device 300 based on detection data input from the CO six-axis sensor 323, and may move the capturing range image 710 in the +Z direction or the −Z direction in response to the determined posture.

For example, assume that the user U holding the control device 300 in the hand has operated the control device 300 to incline an upper side in the longitudinal direction of the touch panel 350 to a side opposite a direction of the user U. The CO control unit 310 detects the inclination, which is posture of the control device 300, based on the detection data input from the CO six-axis sensor 323, and outputs an operation signal corresponding to the detected inclination to the main control unit 123. This moves the capture range image 710 in the −Z direction, which is the back direction of the display region 200.

Further, assume that the user U has operated the control device 300 to incline the upper side in the longitudinal direction of the touch panel 350 to the direction of the user U. The CO control unit 310 detects the inclination, which is posture of the control device 300, based on the detection data input from the CO six-axis sensor 323, and outputs an operation signal corresponding to the detected inclination to the main control unit 123. This moves the capture range image 710 in the +Z direction, which is the front direction of the display region 200.

When the change of display position of the capture range image 710 is complete, the user U presses the OK button 530, and inputs that the change of display position of the capture range image 710 is complete.

Next, upon completion of the change of display position of the capture range image 710, the user U inputs a predetermined operation, such as tapping the operator image 501 twice, to switch the operating target of the virtual joystick controller 500 to the DP outer camera 61.

The user U inputs a predetermined operation by the virtual joystick controller 500 to cause the DP outer camera 61 to perform imaging. The predetermined operation is, for example, operation of long pressing the operator image 501. When the operation of long pressing the operator image 501 is detected in a state in which the operating target is switched to the DP outer camera 61, the CO control unit 310 outputs an imaging instruction to the main control unit 123. When the imaging instruction is input from the CO control unit 310, the main control unit 123 causes the DP outer camera 61 to perform imaging. Further, the main control unit 123 cuts out an image of a region corresponding to the capture range image 710 from a captured image of the DP outer camera 61, and the cut image is caused to be stored in the non-volatile storage unit 130. Thus, the non-volatile storage unit 130 stores imaging of the bottle 620. From the captured image of the DP outer camera 61, the image of the region corresponding to the capture range image 710 is cut out to change an acquisition range of the captured image.

In addition, when the display size of the capture range image 710 is changed by operation of the virtual joystick controller 500, first, the user U touches the guide display 540 to change a display content of the guide display 540 to “DISPLAY SIZE”.

Next, the user U inputs a predetermined operation by the virtual joystick controller 500 to change the display size of the capture range image 710. The predetermined operation is, for example, operation for moving the operator image 501 in the up-down direction.

Upon detecting the operation of moving the operator image 501 in the upward direction, the CO control unit 310 outputs an operation signal corresponding to the detected operation to the main control unit 123. This increases the display size of the capture range image 710. Further, upon detecting the operation of moving the operator image 501 in the downward direction, the CO control unit 310 outputs an operation signal corresponding to the detected operation to the main control unit 123. This decreases the display size of the capture range image 710.

In addition, when the DP outer camera 61 is caused to perform imaging, only the left display unit 24 may be caused to display the capture range image 710, and the DP outer camera 61 may be caused to perform imaging in a state in which the display position of the capture range image 710 is adjusted by operation of the virtual joystick controller 500. The main control unit 123 causes the captured image captured by the DP outer camera 61 at this time to be stored in the non-volatile storage unit 130 as an image for the left eye.

Similarly, when the DP outer camera 61 is caused to perform imaging, only the right display unit 22 may be caused to display the capture range image 710, and the DP outer camera 61 may be caused to perform imaging in a state in which the display position of the capture range image 710 is adjusted by operation of the virtual joystick controller 500. The main control unit 123 causes the captured image captured by the DP outer camera 61 at this time to be stored in the non-volatile storage unit 130 as an image for the right eye.

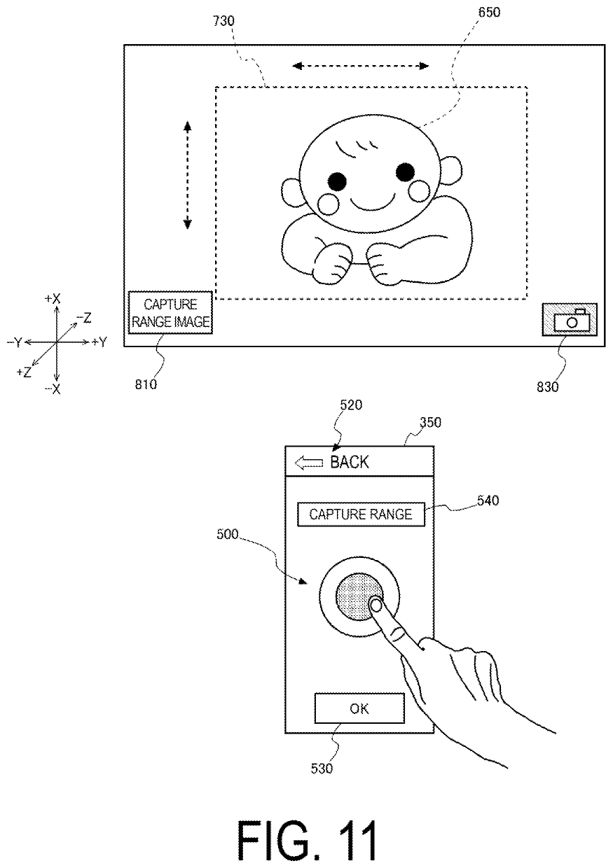

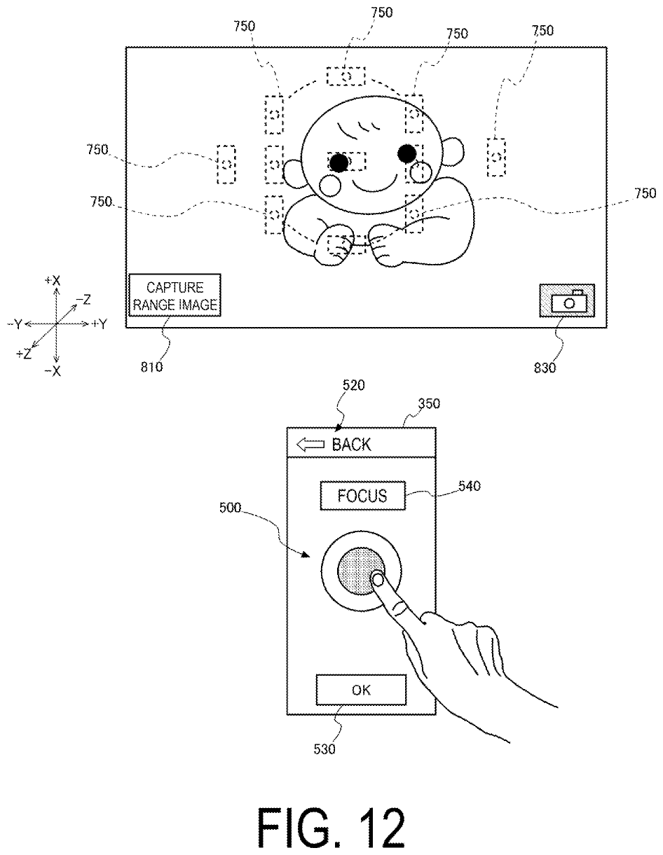

FIGS. 11 and 12 are explanatory diagrams illustrating a case in which the DP outer camera 61 is operated by the virtual joystick controller 500.

Next, the case in which the DP outer camera 61 is operated by the virtual joystick controller 500 will be described with reference to FIGS. 11 and 12.

Hereinafter, a case will be described in which the user U performs adjustment of an imaging range of the DP outer camera 61, or a focus of the DP outer camera 61, by operating the virtual joystick controller 500.

In FIG. 11 and FIG. 12, a baby, which is an imaging subject 650, is visible as an object in the real space to the user U wearing the image display unit 20. Further, a capture range image 730 is visually recognized as a display image displayed by the image display unit 20. The capture range image 730 is also an image indicating a range of a captured image of the DP outer camera 61, to be captured as a capture image.

An image indicated by broken lines in FIG. 11 is the capture range image 730. The capture range image 730 illustrated in FIGS. 11 and 12 is a rectangular image, and is a two-dimensional image having regions in the up-down direction and the left-right direction of the display region 200, which are the X-axis direction and the Y-axis direction.

In addition, when an operating target of the virtual joystick controller 500 is the DP outer camera 61, the second icon 830 in the display region 200 is brought into a state of lighting up or flashing. In FIGS. 11 and 12, a display region of the second icon 830 is hatched, to illustrate a state in which the second icon 830 is selected, and flashes or lights up.

When the operating target of the virtual joystick controller 500 is the DP outer camera 61, a capture range or focus adjustment is displayed in the guide display 540 displayed on the touch panel 350.

Even when the operating target of the virtual joystick controller 500 is the DP outer camera 61, switching of an operation content of the virtual joystick controller 500 can be performed by a touch operation on the guide display 540. When a touch operation on the guide display 540 is detected in a state in which “CAPTURE RANGE” is displayed in the guide display 540 of the touch panel 350, the CO control unit 310 changes the operation content of the virtual joystick controller 500 to “FOCUS ADJUSTMENT”. At this time, the display of the guide display 540 is also changed to the focus adjustment.

Further, when a touch operation on the guide display 540 is detected in a state in which “FOCUS ADJUSTMENT” is displayed in the guide display 540 of the touch panel 350, the CO control unit 310 changes the operation content of the virtual joystick controller 500 to “CAPTURE RANGE”. At this time, the display of the guide display 540 is also changed to the capture range.

The user U moves the operator image 501 of the virtual joystick controller 500 up, down, left, or right as illustrated in FIG. 11 to change a display position of the capture range image 730 so that the imaging subject 650 enters the capture range image 730.

Next, the user U touches the guide display 540 to change the operation content of the virtual joystick controller 500 to the focus adjustment.

FIG. 12 is a diagram illustrating an image displayed in the display region 200, when the operation of virtual joystick controller 500 is changed to the focus adjustment.

When the operation of the virtual joystick controller 500 is changed to the focus adjustment, a plurality of focus points 750 are displayed in the display region 200. The focus point 750 is an adjustment image of the present disclosure and is an image for focus adjustment. When the plurality of focus points 750 are caused to be displayed in the display region 200, the main control unit 123 displays one of the focus points 750 in a flashing state. User U operates the virtual joystick controller 500 to change the focus point 750 in the flashing state. The focus point 750 in the flashing state can be changed to change a position where the DP outer camera 61 focuses. After changing the focus point 750, the user U presses the OK button 530, and input that adjustment of the focus point 750 is complete.

Next, the user U long presses the operator image 501 of the virtual joystick controller 500 to cause the DP outer camera 61 to perform imaging.

When the operation of long pressing the operator image 501 is detected, the CO control unit 310 outputs an imaging instruction to the main control unit 123. When the imaging instruction is input from the CO control unit 310, the main control unit 123 causes the DP outer camera 61 to perform imaging. The main control unit 123, after causing the DP outer camera 61 to perform imaging, cuts out an image of a region corresponding to the capture range image 730 from a captured image of the DP outer camera 61, and causes the cut image to be stored in the non-volatile storage unit 130. As a result, an image of the baby as the imaging subject 650 is stored in the non-volatile storage unit 130. From a captured image of the DP outer camera 61, an image of a region corresponding to the capture range image 730 is cut out to change an acquisition range of the captured image.

Additionally, the capture range image 730 and the focus point 750 may be displayed only in the left display unit 24 of the image display unit 20, and a captured image for the left eye viewed from a viewpoint of the left eye of the user U may be generated.

First, the main control unit 123 causes only the left display unit 24 to display the capturing range image 730, and the CO control unit 310 outputs operation information accepted by operation of the virtual joystick controller 500 to the main control unit 123. The main control unit 123 changes the display position of the capture range image 730 with the input operation information.

Next, the main control unit 123 causes only the left display unit 24 to display the focus point 750, and the CO control unit 310 outputs operation information accepted by operation of the virtual joystick controller 500 to the main control unit 123. The main control unit 123 changes a position where the DP outer camera 61 focuses with the input operation information.

Next, upon accepting an imaging instruction by operation of the virtual joystick controller 500, the CO control unit 310 outputs the accepted information to the main control unit 123. The main control unit 123 causes the DP outer camera 61 to perform imaging, and causes a captured image captured by the DP outer camera 61 to be stored in the non-volatile storage unit 130 as an image for the left eye.

Accordingly, a captured image for the right eye adjusted for the user U wearing the image display unit 20 can be acquired.

Similarly, the capture range image 730 and the focus point 750 are displayed only in the right display unit 22 of the image display unit 20, and a captured image for the left eye viewed from a viewpoint of the right eye of the user U is generated.

First, the main control unit 123 causes only the right display unit 22 to display the capturing range image 730, and the CO control unit 310 outputs operation information accepted by operation of the virtual joystick controller 500 to the main control unit 123. The main control unit 123 changes the display position of the capture range image 730 with the input operation information.

Next, the main control unit 123 causes only the right display unit 22 to display the focus point 750, and the CO control unit 310 outputs operation information accepted by operation of the virtual joystick controller 500 to the main control unit 123. The main control unit 123 changes a position where the DP outer camera 61 focuses with the input operation information.

Next, upon accepting an imaging instruction by operation of the virtual joystick controller 500, the CO control unit 310 outputs the accepted information to the main control unit 123. The main control unit 123 causes the DP outer camera 61 to perform imaging, and causes a captured image captured by the DP outer camera 61 to be stored in the non-volatile storage unit 130 as an image for the right eye.

Accordingly, a captured image for the right eye adjusted for the user U wearing the image display unit 20 can be acquired.

5. Operation

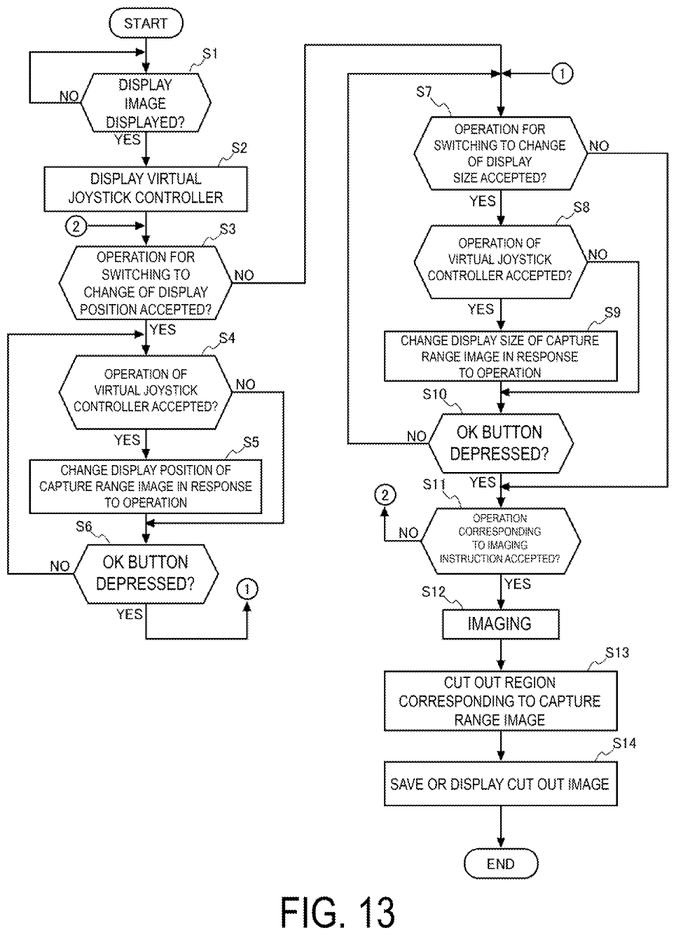

FIG. 13 is a flowchart illustrating operation of a CO control unit.

Operation of the CO control unit 310 will be described with reference to the flowchart illustrated in FIG. 13. Hereinafter, a case will be described in which a capture range is set by the capture range image 710 described with reference to FIGS. 9 and 10, and an image of a captured image of the DP outer camera 61 in a range corresponding to the capture range image 710 is captured.

First, the CO control unit 310 determines whether a display image is displayed in the display region 200 by the image display unit 20 or not (step S1). For example, the CO control unit 310 determines whether operation for requesting display of the capture range image 710 has been accepted by operation of the touch panel 350 or not. When the operation for requesting display of the capture range image 710 has been accepted, the CO control unit 310 determines that the capture range image 710, which is a display image, is displayed in the display region 200 (step S1/YES). When the capture range image 710 is not displayed in the display region 200 (step S1/NO), the CO control unit 310 waits until the capture range image 710 is displayed.

When the capture range image 710 is displayed in the display region 200 (step S1/YES), the CO control unit 310 causes the virtual joystick controller 500 to be displayed on the touch panel 350 (step S2).

Next, the CO control unit 310 determines whether change of display position is set as an operation content of the virtual joystick controller 500 or not (step S3). When the guide display 540 displayed on the touch panel 350 is touched and display of the guide display 540 is changed to “DISPLAY POSITION”, the CO control unit 310 determines that the change of display position is set.

When the operation of the virtual joystick controller 500 is set to the change of display position (step S3/YES), the CO control unit 310 determines whether the operation of the virtual joystick controller 500 has been accepted or not (step S4). When the operation of the virtual joystick controller 500 has not been accepted (step S4/NO), the CO control unit 310 proceeds to determination of step S6. In addition, when the operation of the virtual joystick controller 500 has been accepted (step S4/YES), in response to the operation accepted, the CO control unit 310 changes a display position of the capture range image 710 (step S5). The CO control unit 310 outputs operation information of the virtual joystick controller 500 to the main control unit 123. The main control unit 123 changes the display position of the capture range image 710 in accordance with the operation information input from the CO control unit 310.

Next, the CO control unit 310 determines whether operation for pressing the OK button 530 has been accepted or not (step S6). When the operation for pressing the OK button 530 has not been accepted (step S6/NO), the CO control unit 310 returns to the determination of step S4. In addition, when the operation for the OK button 530 has been accepted (step S6/YES), the CO control unit 310 proceeds to determination of step S7.

When the determination of step S3 was a negative determination, or when the operation for the OK button 530 was accepted in step S6, the CO control unit 310 determines whether operation for changing a display size of the capture range image 710 has been set as the operation of the virtual joystick controller 500 or not (step S7). When the guide display 540 displayed on the touch panel 350 is touched and the display of the guide display 540 is changed to “DISPLAY SIZE”, the CO control unit 310 determines that change of display size is set.

When the operation of the virtual joystick controller 500 is set to the change of display size (step S7/YES), the CO control unit 310 determines whether the operation of the virtual joystick controller 500 has been accepted or not (step S8). When the operation of the virtual joystick controller 500 has not been accepted (step S8/NO), the CO control unit 310 proceeds to determination of step S10. In addition, when the operation of the virtual joystick controller 500 has been accepted (step S10/YES), in response to the operation accepted, the CO control unit 310 changes the display size of the capture range image 710. The CO control unit 310 outputs operation information of the virtual joystick controller 500 to the main control unit 123. The main control unit 123 changes the display size of the capture range image 710 in accordance with the operation information input from the CO control unit 310.

Next, the CO control unit 310 determines whether operation for pressing the OK button 530 has been accepted or not (step S10). When the operation for pressing the OK button 530 has not been accepted (step S10/NO), the CO control unit 310 returns to the determination of step S7. In addition, when the operation for the OK button 530 has been accepted (step S10/YES), the CO control unit 310 proceeds to determination of step 511.

The CO control unit 310 determines whether operation for switching an operating target of the virtual joystick controller 500 to the DP outer camera 61 has been accepted or not (step S11). For example, when the operator image 501 is tapped twice, the CO control unit 310 switches the operating target of the virtual joystick controller 500 to the DP outer camera 61.

When the operation for switching the operating target of the virtual joystick controller 500 to the DP outer camera 61 has not been accepted (step S11/NO), the CO control unit 310 returns to the determination of step S3. In addition, when the operation for switching to the DP outer camera 61 has been accepted (step S11/YES), the CO control unit 310 determines whether operation corresponding to an imaging instruction has been accepted by operation of the virtual joystick controller 500 or not (step S12).

When the operation corresponding to the imaging instruction has not been accepted (step S11/NO), the CO control unit 310 returns to the determination of step S3. In addition, when the operation corresponding to the imaging instruction has been accepted (step S11/YES), the CO control unit 310 outputs an imaging instruction to the main control unit 123 (step S12). When the imaging instruction is input from the CO control unit 310, the main control unit 123 causes the DP outer camera 61 to perform imaging.

When a captured image is input from the DP outer camera 61, the main control unit 123 cuts out an image of a region corresponding to the capture range image 710 from the input captured image (step S13). Thereafter, the main control unit 123 causes the cut image to be stored in the non-volatile storage unit 130 (step S14). In addition, the main control unit 123 controls the image display unit 20 to cause the cut image to be displayed in the display region 200 (step S14).

6. Effect

As described above, the display system 1 according to the present exemplary embodiment includes the HMD 100 and the control device 300 coupled to the HMD 100.

The HMD 100 includes the image display unit 20, with an outside scene visible, for superimposing and displaying an image on the outside scene, and the DP outer camera 61 mounted on the image display unit 20, and is mounted on the head of the user U. The control device 300 has the touch panel 350 for accepting operations.

The virtual joystick controller 500, which is an operation image for accepting operation by the user U, is displayed on the touch panel 350 of the control device 300, and an adjustment image for adjusting the DP outer camera 61, or a captured image captured by the DP outer camera 61 is displayed in the display region 200 of the image of the image display unit 20.

The display system 1 changes display of the adjustment image by operation accepted on the virtual joystick controller 500, and causes the DP outer camera 61 to perform imaging by the operation accepted on the accepted virtual joystick controller 500.

Accordingly, by operating the virtual joystick controller 500 displayed on the touch panel 350, the DP outer camera 61, or the captured image captured by the DP outer camera 61 can be adjusted. With the virtual joystick controller 500 displayed on the touch panel 350, operations corresponding to a joystick controller can be accepted. Thus, the user U touches the display position of the virtual joystick controller 500 with the finger, and moves the touching finger in a direction to input without moving the touching finger away from the touch panel 350. Thus, the number of times that the user U checks the touch panel 350 can be reduced compared to a case where a position of a key is checked each time operation is performed, as with a cross key. Accordingly, operability for the user U wearing the image display unit 20 on the head, and visually recognizing the touch panel 350 through the image display unit 20 can be improved.

The adjustment image displayed in the display region 200 by the image display unit 20 is an image for adjusting an acquisition range of the captured image of the DP outer camera 61, and display of the adjustment image is changed by changing a display position or size of the adjustment image displayed in the display region by operation accepted on the operation image to change an acquisition range of the captured image.

Accordingly, the acquisition range of the captured image captured by the DP outer camera 61 can be changed by operation of the virtual joystick controller 500. Thus, the user U can change the acquisition range of the captured image captured by the DP outer camera 61 mounted on the image display unit 20 without moving the head of the user U. Furthermore, the user U can change the acquisition range of the captured image captured by the DP outer camera 61 by intuitive operations such as operating a joystick controller, and the operability can be improved.

The adjustment image displayed in the display region by the image display unit 20 is the focus point 750 for focus adjustment having a plurality of focal positions, and the focal position where the DP outer camera 61 focuses is selected by operation accepted on the operation image, to change display of the adjustment image, and change the position where the DP outer camera 61 focuses.

Accordingly, the focal position of the DP outer camera 61 can be changed by operation of the virtual joystick controller 500. Thus, the user U can change the focal position of the DP outer camera 61 mounted on the image display unit 20 without moving the head of the user U.

The control device 300 detects a position of the touch panel 350 contacted by the finger of the user U, which is an indicator. The control device 300, with the position of the touch panel 350 where the finger contact of the user U has been detected being a reference, causes the virtual joystick controller 500 to be displayed.

Accordingly, the virtual joystick controller 500 can be displayed at a position of the touch panel 350 where operation by the user U is easy, and the operability can be improved.

The virtual joystick controller 500 has the operator image 501, display position of which is changed in response to operation. The virtual joystick controller 500 has the first display mode, the second display mode, and the third display mode as the display modes.

The first display mode is the form in which the movement direction of the operator image 501 is limited to the up-down direction.

The second display mode is the form in which the movement direction of the operator image 501 is limited to the left-right direction.

The third display mode is the form in which the operator image 501 can be moved in all the directions in the touch panel 350.

In response to the capture range image 710 displayed in the display region 200 by the image display unit 20, the control device 300 causes the virtual joystick controller 500 to be displayed on the touch panel 350 in the display mode of any of the first display mode, the second display mode, and the third display mode.

Accordingly, the virtual joystick controller 500 can be displayed with which the display mode is possible in which a direction that can be accepted by the capture range image 710 displayed in the display region 200 can be input.

7. Modified Example

In the above-described exemplary embodiment, the case is described in which the display image to be an operating target of the virtual joystick controller 500 is the capture range image 710 or 730 that indicates a capture range of the captured image. In this modified example, a case is described in which a display image is associated with an actual object in a real space, and is an image superimposed and displayed on the actual object, and operation for changing a display position of the display image is performed by the virtual joystick controller 500.

The main control unit 123 causes the DP outer camera 61 to perform imaging, and detects a pre-registered registered object from a captured image. When the registered object is detected from the captured image, the main control unit 123 causes the image display unit 20 to display a display image associated with the registered object.

When the display image displayed in association with the actual object is displayed by the image display unit 20, the user U long presses the operator image 501 of the virtual joystick controller 500 for a preset amount of time or longer. When the operation of long pressing the operator image 501 is accepted, the CO control unit 310 allows change of the display position of the display image associated with the actual object.

Next, the user U moves the display image to a position where the display image is to be displayed while long pressing the operator image 501. When the movement of the control device 300 is detected by sensor data of the CO six-axis sensor 323 while the operator image 501 is long pressed, the CO control unit 310 detects moving amount of the moved control device 300 from the sensor data of the CO six-axis sensor 323.

When the display image is moved to the position to display, the user ends the long press operation of the operator image 501. When the long press of the operator image 501 is no longer detected, the CO control unit 310 moves the display position of the display image by the moving amount detected by the sensor data of the CO six-axis sensor 323.

That is, in the modified example, a preset registered object included in an outside scene is detected from a captured image captured by the DP outer camera 61, and when the registered object is detected, the image display unit 20 is caused to display a display image associated with the registered object at a position corresponding to the registered object, and when a preset operation on an operation image is accepted, moving amount of the control device 300 is detected, and a display position of the display image is changed in response to the detected moving amount of the control device 300.

Accordingly, the display position of the display image associated with the registered object can be adjusted by a possible operation of the virtual joystick controller 500.

The present disclosure is not limited to the configurations in the exemplary embodiments described above, and the present disclosure can be implemented in various aspects without departing from the gist of the disclosure.

For example, the configuration has been illustrated in which the display system 1 includes the head mounted display device HMD 100, but the present disclosure is not limited thereto, and various types of display devices can be employed. For example, instead of the image display unit 20, for example, another type of image display unit such as an image display unit to be worn like a cap, for example, may be employed. Such an image display unit may include a display unit configured to display images corresponding to the left eye LE of the user U and a display unit configured to display images corresponding to the right eye RE of the user U. Additionally, the display device may be configured, for example, as a head mounted display mounted on a vehicle such as a car, and an airplane. Further, the display device may be configured, for example, as a head-mounted display built into a body protector tool such as a helmet. In such a case, a portion for positioning the apparatus with respect to the body of the user U, and a portion positioned with respect to the portion described earlier can be a mounting section of the head-mounted display apparatus.

The HMD 100 is an example of a display device to which the present disclosure is applied, and is not limited to the configuration illustrated in FIG. 3. For example, the configuration in which the image display unit 20 and the connection device 10 are separated has been described as an example in the exemplary embodiment described above, but the connection device 10 and the image display unit 20 may be integrally configured to be mounted on the head of the user U. Further, the configuration of the optical system of the image display unit 20 is optional, and for example, an optical member positioned in front of the eye of the user U and overlapping a part or all of the field of view of the user U may be used. Alternatively, a scanning type optical system may be adopted that makes imaging light by scanning with laser light or the like. Alternatively, in addition to the optical system in which imaging light is guided inside the optical member, an optical system may be used that only has a function of refracting and/or reflecting imaging light to guide toward the eye of the user U.

Further, as the display device, a liquid crystal monitor or a liquid crystal television that displays an image on a liquid crystal display panel may be employed. A display device including a plasma display panel, or an organic EL display panel may be used. Further, as the display device, a projector that projects imaging light onto a screen or the like may be used.

Further, for example, in the HMD 100 illustrated in FIG. 3, the connection device 10 may be configured using a USB-TypeC connector, a USB-TypeC controller, and a USB hub. In this case, the DP outer camera 61 and other sensors may be coupled to the USB hub. Additionally, an FPGA that outputs display data to the right display unit 22 and the left display unit 24 may be arranged, in either the right display unit 22 or the left display unit 24, as a controller for controlling display of the right display unit 22 and the left display unit 24 in the image display unit 20. In this case, the connection device 10 may include a bridge controller that couples the USB-TypeC controller and the FPGA. Additionally, the image display unit 20 may have a configuration in which the DP six-axis sensor 235, the DP magnetic sensor 237, the EEPROM 215, and the like, and the FPGA are mounted on the same substrate. The arrangement of the other sensors can also be changed accordingly. For example, a configuration may be adopted in which the distance sensor 64 and the DP illuminance sensor 65 are arranged at locations suitable for measurement or detection, and coupled to the FPGA or the USB-TypeC controller.

Further, there is no limitation on the specific specifications of the display device including the OLED units 221 and 241, and for example, the OLED units 221 and 241 may have a common configuration.

At least some of the functional blocks illustrated in FIGS. 3 and 4 may be achieved in the form of hardware or may be achieved by a cooperation of hardware and software, and, is not limited to a configuration in which independent hardware resources are arranged as illustrated in the drawings. Further, a configuration may be adopted in which as a program executed by the processor 311, a program stored in an external device is acquired via the communication unit 342 or the I/F unit 343 to be executed.

What is claimed is:

1. An operating method of a display system including a display device including a display unit through which an outside scene is visible and configured to display an image superimposed on the outside scene, and an imaging unit mounted on the display unit, the display device being configured to be mounted on a head of a user, and an information processing device having an operating surface for accepting operation, the operating method comprising:
displaying an operation image for accepting operation by the user on the operating surface;
displaying an adjustment image, for adjusting the imaging unit or a captured image captured by the imaging unit, in a display region of an image of the display unit;
changing display of the adjustment image by operation accepted on the operation image; and
causing the imaging unit to perform imaging by the operation accepted on the operation image.

2. The operating method according to claim 1, wherein
the operation image includes an operator, display position of which on the operating surface is changed by operation, and
input by the user is identified, based on a display position of the operator before the operation is accepted, and a display position of the operator after the operation is accepted.

3. The operating method according to claim 1, wherein
the adjustment image displayed in the display region by the image display unit is an image for adjusting an acquisition range of a captured image of the imaging unit, and
display of the adjustment image is changed by changing a display position or size of the adjustment image displayed in the display region by operation accepted on the operation image, and thus the acquisition range of the captured image is changed.

4. The operating method according to claim 1, wherein
the adjustment image displayed in the display region by the image display unit is an image for a focus adjustment having a plurality of focal positions, and
display of the adjustment image is changed by selecting the focal position where the imaging unit focuses by operation accepted on the operation image, and thus the position where the imaging unit focuses is changed.

5. The operating method according to claim 1, wherein
a position of the operating surface contacted by an indicator is detected, and
the operation image is displayed with the position of the detected operating surface as a reference.

6. The operating method according to claim 1, wherein
the operation image has an operator, display position of which is changed in response to operation, and
the operating method includes
a first display mode in which a movement direction of the operator is limited to a first direction,
a second display mode in which the movement direction of the operator is limited to a second direction different from the first direction, and
a third display mode in which the operator is configured to move in all directions on the operating surface,
in response to the adjustment image displayed in the display region by the display unit, the operation image in any of the first display mode, the second display mode, and the third display mode is displayed on the operating surface.

7. The operating method according to claim 1, wherein
a preset registered object included in the outside scene is detected from a captured image captured by the imaging unit,
when the registered object is detected, a display image associated with the registered object is displayed by the display unit at a position corresponding to the registered object,
when a preset operation on the operation image is accepted, moving amount of the information processing device is detected, and
a display position of the display image is changed in response to the detected moving amount of the information processing device.

8. The operating method according to claim 1, wherein
the display unit includes a left display unit for causing a left eye of the user to visually recognize an image, and a right display unit for causing a right eye of the user to visually recognize an image,
in a state where the left display unit displays the adjustment image, operation on the operation image is accepted, and display of the adjustment image is changed by the operation accepted,
operation on the operation image is accepted, and the operation accepted causes the imaging unit to perform imaging by the operation accepted to acquire a captured image for the left eye,
in a state where the right display unit displays the adjustment image, operation on the operation image is accepted, and display of the adjustment image is changed by the operation accepted, and
operation on the operation image is accepted, and the operation accepted causes the imaging unit to perform imaging by the operation accepted to acquire a captured image for the right eye.
